(19) United States
(12) Patent Application Publication
(10) Pub. No.: US 2004/0191731 A1
(43) Pub. Date: Sep. 30, 2004

(54) Paper document-based assistive technologies for the visually impaired

(76) Inventor: David G. Stork, Portola Valley, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/404,710

(22) Filed: Mar. 31, 2003

(51) Int. Cl. G09B 21/00; G09B 17/04; G09B 19/00

(52) U.S. Cl. 434/180; 434/112

(57) ABSTRACT

A method and an apparatus to help visually impaired people read paper-based documents are disclosed. In one embodiment, the method includes receiving information of the readers, scanning in the paper-based document, analyzing the scanned document and re-rendering the scanned document based on the information of the readers. The method may further include printing the re-rendered document.

### FIELD OF INVENTION

The present invention relates to assistive technologies for people with disabilities, and more particularly, to paper-based assistive technologies for helping visually and cognitively impaired people to read.

### BACKGROUND

There is a wide variety of visual and cognitive conditions that impair the ability to read or otherwise understand documents. These include non-specific “low vision,” macular degeneration, retinitis pigmentosa, amblyopia, dyslexia, various aphasias, color deficiency, and more. These conditions affect a large number of people. For instance, it is estimated that there are seven million dyslexic individuals in the United States who experience difficulty reading. Moreover, as the population ages, the number of well-documented age-related vision problems will increase. In 2000, the number of seniors (i.e., 65 and older) was 12.4% of the American population, a proportion that increased 12.0% since 1990. Those aged 45-64 increased by 34% during this period.

In response to the growing needs of people with disabilities or health problems, both the government and the scientific community devote significant resources to improve the accessibility of programs and activities to individuals with disabilities or health problem. A vast majority of research addresses interfaces, for instance computer interfaces to on-line digital libraries, that may be used by such individuals. There has been research on making online documents, particularly webpages, accessible to the visually impaired. Typically, this work employs specific style sheets that enlarge text, change font, color, column widths, and so on, implemented as a plug-in for a web browser or style sheet selection for a word processing program. However, it is clear that the above approach cannot work directly with existing paper documents, such as magazines, newspapers, bound books, labels on medicine boxes, business letters, etc.

To work directly with existing paper documents, an expensive special-purpose camera and screen are sometimes used. FIGS. 1A and 1B show examples of the existing special-purpose cameras and screens. In FIG. 1A, a NanoPac reading assistant employs a camera in a manipulatable mouse. The mouse is shown in the insert of FIG. 1A. The mouse is linked to a cathode ray tube (“CRT”) screen. A user sweeps the camera in the mouse over the text of a document. The camera captures the text, which is enlarged and displayed on the CRT screen a few words at a time. However, sweeping requires constant attention by the user, and sweeping back to the beginning of the following line can be inaccurate and hence confuse and slow the reader. Furthermore, such a system has a drawback in that reading is confined to a computer screen.

In FIG. 1B, another existing reading assistant, the OptoLec reading assistant is shown. The OptoLec reading assistant employs a camera mounted above a document to be read. The human reader can sweep the camera over the document to capture the text in the document. Similar to the NanoPac reading assistant, the text is displayed in enlarged format a few words at a time on the screen.

These camera-based systems have a number of drawbacks. First, they are expensive, with a cost of several hundred dollars. Second, they are single-purpose devices that take up significant space on a table or desk. Also, their screens are heavy and fixed in place. Therefore, the position of the reader and the viewing angle are severely restricted. Moreover, they are not portable because they are heavy and require electrical power connection. Furthermore, their display screens are invariably lower-resolution than paper. In addition, each reading assistant supports only a few users at a time, and the few users are forced to read at the same rate rather than independently at their own pace.

Besides the physical limitations of the reading assistants, the reading assistants do not provide re-flow or re-layout of the text, so only a narrow swath of the full printed text width is visible in the display screen at any moment. Hence for the vast majority of printed documents, the reader must scan back and forth across the page, which is inconvenient for the elderly and the physically disabled. Another problem with scanning back and forth across the page is that it is difficult to find the correct subsequent line on the left after completing the previous line. Finally, these reading assistants are purely image based and do not analyze the content of the document. Therefore, these reading assistants provide no help to readers with cognitive deficiencies that impair their reading ability, such as dyslexia.

### BRIEF DESCRIPTION OF THE DRAWINGS

Embodiments of the present invention will be understood more fully from the detailed description that follows and from the accompanying drawings, which however, should not be taken to limit the invention to the specific embodiments shown, but are for explanation and understanding only.

FIG. 1A shows a NanoPac reading assistant.

FIG. 1B shows an OptoLec reading assistant.

FIG. 2 shows a flow diagram of one embodiment of a process for assisting the visually impaired to read paper-based documents.

FIG. 3 is a block diagram of one embodiment of a system to assist the visually impaired to read paper-based documents.

FIG. 4 shows an example of re-rendered text with phonetic transcriptions.

FIG. 5 shows an example of re-rendered text gradually increasing in text size.

FIG. 6 shows an exemplary embodiment of a multi-function machine or copier.

### DETAILED DESCRIPTION

A method and an apparatus to assist the visually impaired to read paper-based documents are described. In the following description, numerous details are set forth, such as specific configurations, operations, etc., in order to provide a thorough understanding of embodiments of the present invention. It will be clear, however, to one of ordinary skill in the art, that these specific details may not be needed to practice every embodiment of the present invention. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus such as a photocopier or multi-function peripheral (e.g., printer) for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular photocopier, multi-function peripheral (printer), computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

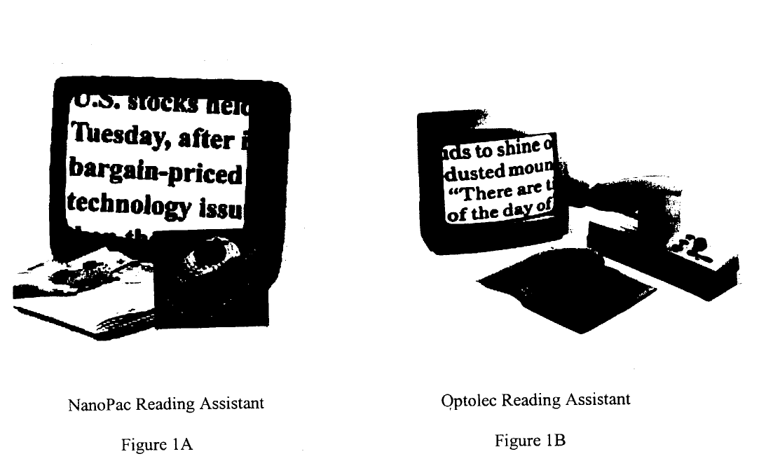

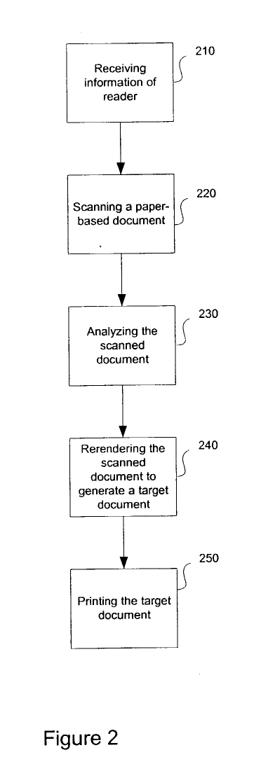

FIG. 1 shows a flow diagram of one embodiment of a process for assisting the visually impaired to read paper-based documents. The process is performed by processing logic that may comprise hardware (e.g., circuitry, dedicated logic, etc.), software (such as is run on a general purpose computer system or a dedicated machine such as a multifunction printer, copier, etc.), or a combination of both.

Referring to FIG. 1, the process includes receiving information of an individual (processing block 210). The information of the individual may include the name of the reader, billing information, the type of disability of the reader, such as dyslexia, macular degeneration, or the like, and the severity of the disability (e.g., mild, severe, very severe, etc.), the prescription of the individual, the document display preference of the individual, etc. In one embodiment, the information is read from a card, such as, for example, a debit card or a medical insurance card. In another embodiment, a user enters the information by pressing a button on a machine, using a keypad, keyboard, a touch-screen with a graphical user interface, or other well-known user interface device. Each button may indicate a disability and/or its severity. In another embodiment, the user selects or specifies a display preference file among a set of pre-existing display preference files.

The process further includes scanning in a paper-based document that the individual wants to read (processing block 220). Scanning can be done either before or after receiving the information of the individual. The document can be any paper-based document, such as, for example, newspaper, magazines, labels on medicine boxes, printed sheet music, timetables, etc.

The scanned document is then analyzed (processing block 230). The analysis may include page segmentation to separate text and figures in the scanned document, layout and reading order analysis, as well as performing word bounding box extraction. In one embodiment, the process includes performing optical character recognition during the analysis. Other types of document analysis are performed in various embodiments to allow proper re-rendering of the document.

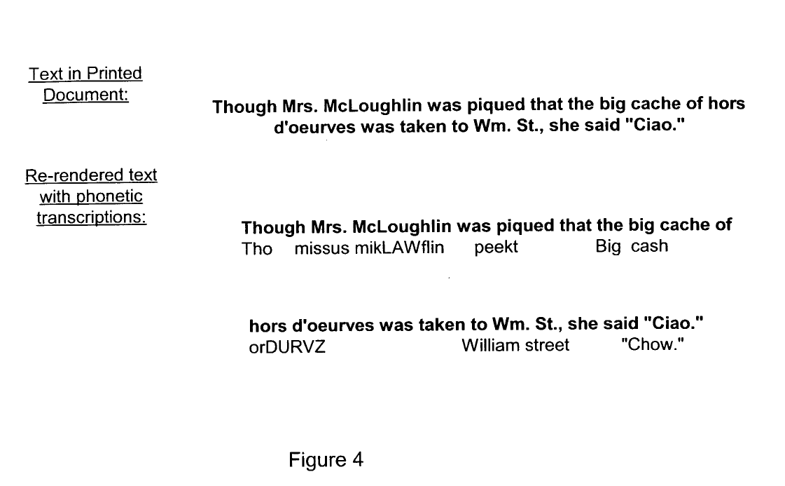

After analyzing the scanned document, the document is re-rendered according to the information of the reader to generate a target document (processing block 240) in a format that compensates for the disability of the reader. Re-rendering the scanned document is converting the document into another form. Different embodiments of re-rendering include various processes. In one embodiment, re-rendering includes enlarging the text. The enlargement may be done by expanding pixel images of word boxes, by scaling the space in the document, or by resetting the optical character recognition results with a larger type font, or any other well-known text enlargement process. In one embodiment that resets the optical character recognition results, the text can be set in a Sans Serif font, such as Arial, which is known to a font that dyslexic people are better able to read. In another embodiment, the spacing between lines is increased during re-rendering. In another embodiment, re-rendering includes adding phonetic transcriptions of difficult words and/or abbreviations beneath the text in the document. FIG. 4 shows an example of text with phonetic transcriptions.

In one embodiment, the processing uses reading order information extracted during the analysis phase to reflow text to fit the spatial dimensions of the target document. One embodiment makes the target document easier to read by enhancing contrast or correcting colors in the document. In another embodiment, the figures extracted in the analysis are scaled to fit within a page of the target document. In another embodiment, the text and the figures of the document are re-ordered such that all the figures are placed at one location (e.g., at the end) in the target document. In another embodiment, the text and the figures are re-organized in the target document to reduce visual clutter. One way to reduce visual clutter in the target document is to remove textured backgrounds from the scanned document. Different embodiments employ other techniques to reduce visual clutter.

In another embodiment, re-rendering includes color-coding the document. Difficult or reversal letters, such as “d” versus “b” and “p” and “q”, are color-coded. Furthermore, the last word in a line and the first word in the following line are color-coded to aid the reader in finding immediately subsequent lines of text while reading. In another embodiment, the color of the background of the document is converted to a particular color (e.g., murky green) to make it easier for dyslexic people to read. One should appreciate that the embodiments of re-rendering described above are for illustration only. Other embodiments may include different processes or combinations of processes.

After re-rendering the scanned document to generate the target document, the target document is printed out on paper (processing block 250). A reader can carry the paper printout of the target document anywhere to read at any time. Furthermore, readers can read their paper printout at their own pace. Unlike using the existing reading assistants, the reader is not restricted to a certain location to read the target document. Moreover, the paper printout allows readers to read the target document in private, and thus, readers can keep their disability in private.

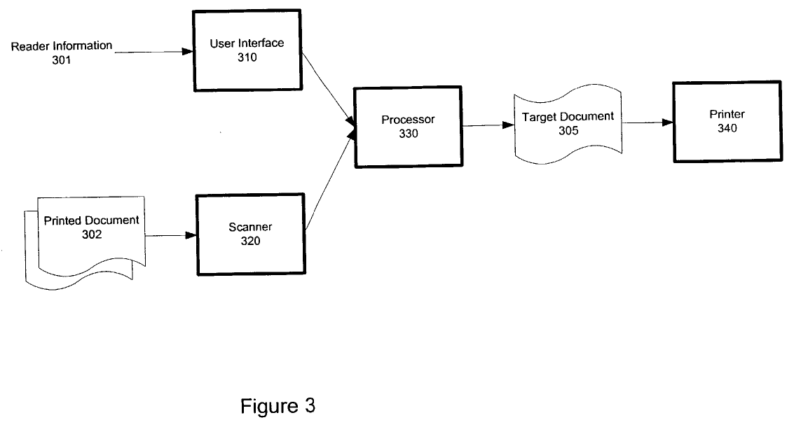

In FIG. 3, a system 300 to assist the visually impaired to read paper-based documents is shown. The system includes a user interface 310, a scanner 320, a processor 330, and a printer 340. The scanner 320 scans paper-based document 302 that a reader wants to read. Examples of the paper-based document include newspaper, magazine, labels on medicine boxes, letters, printed sheet music, timetables, etc.

The system 300 also includes a user interface 310 to receive user information 301. The user information 301 may include the name of the user, social security number, billing information, and information on the disability of the reader. In one embodiment, user interface 310 includes a card reader (not shown) to read electronic cards storing reader information 301, such as a debit card or an insurance card. In another embodiment, user interface 310 includes a touch-screen and a graphic user interface to allow a user to enter the information via the touch screen. In another embodiment, user interface 310 includes a keypad or a keyboard to allow a user to type in the information. In another embodiment, user interface 310 includes buttons, which the user can press to enter the information. It should be appreciated that implementations of user interface 310 described above are for illustration only. Interface 310 may be implemented in other ways in various embodiments.

The system 300 in FIG. 3 further includes a processor 330. In one embodiment, processor 330 is a general-purpose processor, such as a microprocessor in a generic computer system. In another embodiment, processor 330 is a special-purpose processor embedded in a copy machine. Processor 330 runs software to analyze the scanned document. In one embodiment, processor 330 separates the text from the figures in the document, analyzes the layout and reading order of the document, and extracts word bounding box. In another embodiment, processor 330 performs optical character recognition.

After the analysis of the document, processor 330 re-renders the document based on the results of the analysis and the information of the reader. Processor 330 runs software that re-renders the document in various ways to generate a target document, which compensates for different types and severity of disability of the readers. Detailed discussion on re-rendering for low vision, dyslexia, and macular degeneration is provided below for illustration only. It should be apparent that the present invention is not limited to compensating for only these disabilities, nor the techniques described below.

For people with low vision, one embodiment of the present invention enlarges the text in the scanned document. Another embodiment performs optical character recognition on the text and changes the font of the text in the target document. Another embodiment of the present invention increases the contrast of the text and the background in the target document (e.g., by changing colors of the text and/or background).

For people with dyslexia, various techniques can be employed to compensate for the disorder. In one embodiment, one or more of the following may be employed to help people with dyslexia. Phonetic transcriptions under the words in the target document may be provided, particularly abbreviations and words that typically cause reading problems for dyslexic people. An example of text with phonetic transcription is shown in FIG. 4. The font of the text is changed to San Serif, which is known to be easier for dyslexic people to read. The layout in the target document may be changed, such as, for example, by organizing the text in narrower columns, increasing word spacing, and/or converting to larger font sizes. Also the background in the target document may be changed to a particular color (e.g., murky green) to make it easier for dyslexic people to read. Moreover, the last word of a line and the first word of the following line are color-coded with the same color to enable the reader to readily find the following line more easily.

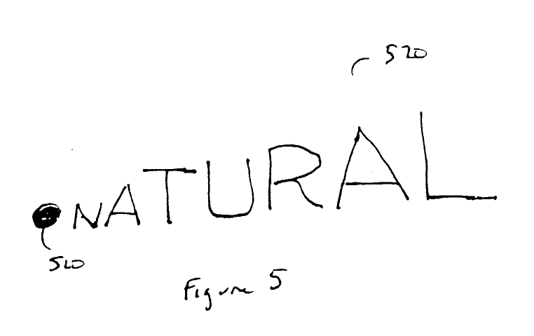

For people with macular degeneration, cells in areas in their eyes near the center of the retina degenerate, causing blurred vision. To help an individual with macular degeneration read easier, one or more of the following may be done. The text is re-rendered to be off to the side so that the image of the text would not fall within the blind spot of the reader. Inter-word spacing is increased. A fixation point is marked in the document corresponding to the blind spot of an individual with macular degeneration, and the text size, both height and width, is gradually increased as the text moves away from the blind spot to make the text appear in equivalent resolution to the individual because resolution decreases as the image of text moves away from the center of the retina. An example of text gradually increasing in text size is shown in FIG. 5. The word “NATURAL” 520 gradually increases in size as it moves away from the fixation point 510.

Furthermore, other techniques can be employed in various embodiments to make the target document easier to read in general. For example, in one embodiment, the reading order of the text is simplified. In another embodiment, the figures and photos in the document are enlarged and/or are put at a particular location in the target document (e.g., at the end of the document). It should be appreciated that the techniques described here are for illustration only, and the present invention is not limited to only these techniques.

After processor 330 has re-rendered the document to generate a target document 305, target document 305 is sent to a printer 340. Printer 340 prints target document 305 on paper. Printing the target document on paper allows readers to carry the target document with them and read the document wherever they prefer. Furthermore, readers can read their own copies of the target document at their own pace without getting into the way of other readers who need to use the system 300. In addition to the benefits of portability and convenience, the target document on paper provides the benefit of enabling the readers to read the document in private, and thus, to keep their disability private. Moreover, printing the target document on paper allows readers to read the target document any time they desire once they get the printout of the target document. They do not have to wait until a reading assistant becomes available to read.

In addition to the convenience to the readers, the system 300 is also more efficient and economical than the existing reading assistants. The time a user spends on using a reading assistant is longer than the time spent on using the system 300 because a person typically takes more time to read a document than to scan and print a document. As a result, the system 300 serves more people than the reading assistant does. Therefore, the system 300 is more economical and efficient than reading assistants.

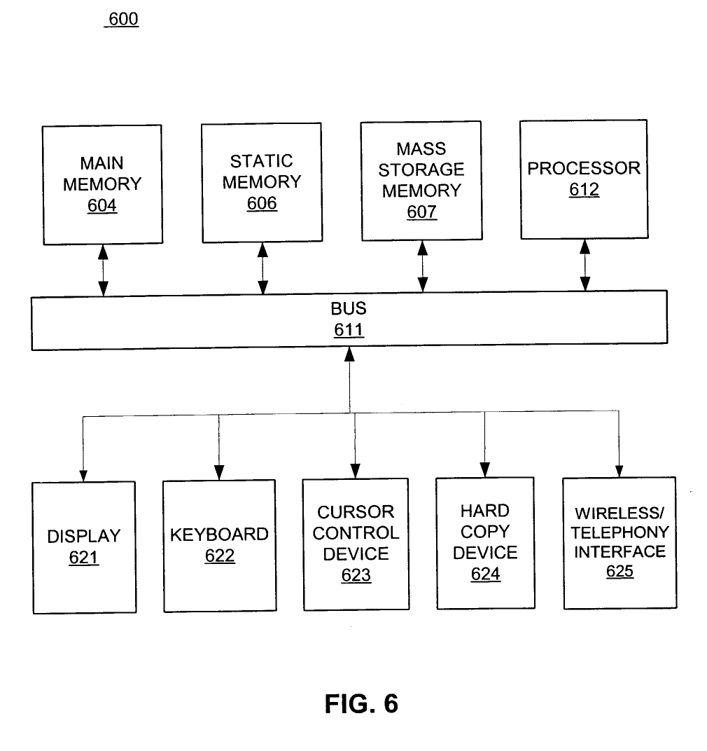

FIG. 6 is a block diagram of an exemplary system that may perform one or more of the operations described herein. This system may be part of a multi-function peripheral (e.g., printer), copier, etc. Referring to FIG. 6, system 600 may comprise an exemplary client 650 or server 600 computer system. System 600 comprises a communication mechanism or bus 611 for communicating information, and a processor 612 coupled with bus 611 for processing information. Processor 612 includes a microprocessor, but is not limited to a microprocessor, such as, for example, Pentium™, PowerPC™, Alpha™, etc.

System 600 further comprises a random access memory (RAM), or other dynamic storage device 304 (referred to as main memory) coupled to bus 611 for storing information (e.g., image data) and instructions to be executed by processor 612. Main memory 604 also may be used for storing temporary variables or other intermediate information during execution of instructions by processor 612.

System 600 also comprises a read only memory (ROM) and/or other static storage device 606 coupled to bus 611 for storing static information and instructions for processor 612, and a data storage device 607, such as a magnetic disk or optical disk and its corresponding disk drive. Data storage device 607 is coupled to bus 611 for storing information and instructions.

System 600 may further be coupled to a display device 621, such as a cathode ray tube (CRT) or liquid crystal display (LCD), coupled to bus 611 for displaying information to a computer user. An alphanumeric input device 622, including alphanumeric and other keys, may also be coupled to bus 611 for communicating information and command selections to processor 612. An additional user input device is cursor control 623, such as a mouse, trackball, trackpad, stylus, or cursor direction keys, coupled to bus 611 for communicating direction information and command selections to processor 612, and for controlling cursor movement on display 621.

Another device that may be coupled to bus 611 is hard copy device 624, which may be used for printing instructions, data, or other information on a medium such as paper, film, or similar types of media.

Furthermore, a scanning device may optionally be coupled to bus 611 for interfacing with system 600. In one embodiment, system 600 includes an automatic document feeder

Another device that may be coupled to bus 611 is a wired/wireless communication capability 625 to communicate with a phone or handheld palm device.

Note that any or all of the components of system 600 and associated hardware may be used in the present invention. However, it can be appreciated that other configurations of the computer system may include some or all of the devices.

The foregoing discussion merely describes dome exemplary embodiments of the present invention. One skilled in the art will readily recognize from such discussion, the accompanying drawings and the claims that various modifications can be made without departing from the spirit scope of the invention.

What is claimed is:

1. A method comprising:
receiving visual or cognitive impairment information of an individual;
receiving a document;
analyzing the document; and
re-rendering the document onto paper responsive to the impairment information of the individual.

2. The method of claim 1, further comprising printing the re-rendered document.

3. The method of claim 1, wherein receiving the information of the individual comprises reading a card.

4. The method of claim 1, wherein the information of the individual includes one or more of a group consisting of information of a disability of the individual, prescription of the individual, and document display preference of the individual.

5. The method of claim 1, wherein analyzing the document comprises:
separating text in the document from one or more figures in the document;
performing word bounding box extraction; and
performing layout and reading order analysis.

6. The method of claim 1, wherein analyzing the document further comprises performing optical character recognition.

7. The method of claim 1, wherein re-rendering the document comprises modifying text size in the document.

8. The method of claim 1, wherein re-rendering the document comprises modifying text contrast in the document

9. The method of claim 8, wherein modifying text size in the document includes expanding pixel image of the text and changing scale of space between words and between lines in the document.

10. The method of claim 1, wherein re-rendering the document comprises modifying figure size and figure contrast in the document.

11. The method of claim 1, wherein re-rendering the document comprises changing text font in the document.

12. The method of claim 1, wherein re-rendering the document comprises adding phonetic transcriptions of one or more words in the document.

13. The method of claim 1, wherein re-rendering the document comprises modifying document layout.

14. The method of claim 13, wherein modifying the layout of the document includes formatting the text into a plurality of columns, wherein the plurality of columns are narrower than columns in the document.

15. The method of claim 13, wherein modifying the layout of the document includes increasing word spacing.

16. The method of claim 13, wherein modifying the layout of the document includes reordering text in the document and rearranging one or more figures to one or more different locations in the document.

17. The method of claim 1, wherein re-rendering the document comprises changing colors in the document.

18. The method of claim 17, wherein changing colors includes changing background color of the document to murky green.

19. The method of claim 1, wherein re-rendering the document comprises color-coding the document.

20. The method of claim 19, wherein color-coding the document comprises applying a color to a last word of a first line in the document and applying the color to a first word of a second line in the document, the second line immediately following the first line.

21. The method of claim 1, wherein re-rendering the document comprises:
marking fixation points in the document; and
increasing text size according to how far the text is from the fixation point.

22. The method of claim 1, wherein receiving the document comprises scanning the document.

23. An apparatus comprising:
a user interface to receive visual impairment information of a reader;
a scanner to scan in a paper-based document; and
a processor to analyze the scanned document and to re-render the scanned document responsive to the information of the reader.

24. The apparatus of claim 23, further comprising a printer to print the re-rendered document.

25. The apparatus of claim 23, wherein the user interface comprises a car reader to read a card storing the information of the reader.

26. The apparatus of claim 23, wherein the information of the reader includes one or more of a group consisting of information of a disability of the reader, prescription of the individual, and document display preference of the individual.

27. The apparatus of claim 23, wherein the processor separates text in the scanned document from one or more figures in the scanned document, performs word bounding box extraction, and analyzes layout and reading order of the scanned document.

28. The apparatus of claim 27, wherein the processor performs optical character recognition.

29. The apparatus of claim 23, wherein the processor modifies text size in the document.

30. The apparatus of claim 23, wherein the processor modifies text contrast in the document.

31. The apparatus of claim 30, wherein the processor expands pixel image and changes scale of space in the document.

32. The apparatus of claim 23, wherein the processor modifies figure size and figure contrast in the document.

33. The apparatus of claim 23, wherein the processor adds phonetic transcription of one or more words in the document.

34. The apparatus of claim 23, wherein the processor modifies layout of the document.

35. The apparatus of claim 34, wherein the processor puts text of the scanned document into a plurality of columns to modify the layout of the document, the plurality of columns are narrower than columns in the scanned document.

36. The apparatus of claim 34, wherein the processor increases word spacing to modify the document layout.

37. The apparatus of claim 34, wherein the processor reorders text in the document and rearranges one or more figures to one or more different locations in the document.

38. The apparatus of claim 23, wherein the processor changes colors of the document.

39. The apparatus of claim 37, wherein the processor changes background color of the document to murky green.

40. The apparatus of claim 23, wherein the processor color-codes the document.

41. The apparatus of claim 40, wherein the processor applies a color to a last word of a first line in the document and applies the color to a first word of a second line in the document, the second line immediately following the first line.

42. The apparatus of claim 23, wherein the processor marks a fixation point in the document and increases text size according to how far the text is from the fixation point.
